(19) United States
(12) Patent Application Publication
(10) Pub. No.: US 2017/0118520 A1
(43) Pub. Date: Apr. 27, 2017

(54) Personalized Smart TV Management System and Method for Pushing information to Television Device

(71) Applicant: OVOMEDIA CREATIVE INC., Zhubei City (TW)

(72) Inventors: YU SHUN WU, Zhubei City (TW); CHIH-HAO CHIU, Zhubei City (TW)

(21) Appl. No.: 15/252,755

(22) Filed: Aug. 31, 2016

(30) Foreign Application Priority Data
Oct. 23, 2015 (TW) 104134938

(51) Int. Cl. H04N 21/4782; H04N 21/422; H04N 21/488

(52) U.S. Cl. CPC H04N 21/4782; H04N 21/4882; H04N 21/42207

(57) ABSTRACT

A personalized smart television management system has an operation system for providing an image to a display apparatus. The system has a user interface comprising a live broadcasting area, an application program area and a demand area. The live broadcasting area is disposed on a first block of a display area of the display apparatus. The application program area is disposed on a second block of the display area of the display apparatus. The demand area is disposed on a third block of the display area of the display apparatus. The demand area displays notification video messages of multiple application programs of the application program area. When a user points a virtual indicator toward a specific notification video message block of the demand area through a user control interface device, a preview playback of a specific notification video message in the specific notification video message block starts.

This application claims priority of No. 104134938 filed in Taiwan R.O.C. on 2015 Oct. 23 under 35 USC 119, the entire content of which is hereby incorporated by reference.

### BACKGROUND OF THE INVENTION

Field of the Invention

The invention relates to the technology of a smart video television (TV) box or a smart television, and more particularly to a personalized smart television management system.

Description of the Related Art

Since the broadcasting television is provided, presentation contents of home entertainment display apparatuses are controlled by associated providers for a long period of time, and people only have few choices. With the coming of the Internet era, people have new choices on the televisions, and the smart televisions were born accordingly.

A typical smart video television box or smart television, such as APPLE TV of Apple Inc. or Android television box, has a built-in operation system. FIG. 1A is a schematic view showing a conventional operation interface of a smart video television box with the Android operation system. Referring to FIG. 1A, after the smart video television box is completed booted up, the operation interface is entered. The operation interface comprises a navigation field 101, an application program field 102 and a desktop block 103. The application program field 102 comprises multiple application programs 104 and an application program drawer field 105. The operation interface is extremely similar to an operation interface of a mobile phone with the Android operation system or an operation interface of a tablet computer with the Android operation system. The difference therebetween only resides in that the smart video television box is operated by way of remote control.

FIG. 1B is a schematic view showing a conventional operation interface of an APPLE TV television box. Referring to FIG. 1B, when the smart video television box is completely booted up, the operation interface is entered. The operation interface comprises a movie recommendation field 106 and an application program field 107. The movie recommendation field 106 shows multiple recommended movies. The user can play back the movie by way of clicking, inputting account passwords or credit card payment. The application program field 107 can open the application program built in the APPLE TV television box.

However, the user's expect to the smart video television box or smart television is not an interface like a smart portable device only, and the user expects to watch the television immediately or watch his/her interested push notifications immediately without any complicated operation after the operation interface is entered.

### SUMMARY OF THE INVENTION

An object of the invention is to provide a personalized smart television management system capable of making a user immediately watch a live television broadcast, an application program and a video/audio notification pushed by the application program after the user powers on the personalized smart television management system. More particularly, when the user moves a virtual indicator to a demand area, the preview playback can be performed without any clicking operation.

In view of this, the invention provides a personalized smart television management system, which has an operation system and for providing an image to a display apparatus. The personalized smart television management system comprises a network access circuit, a storage circuit, a control circuit and a user control interface device. The network access circuit is to be connected to Internet. The storage circuit is for storing the operation system and multiple application programs. The control circuit is coupled to the network access circuit and the storage circuit and for operating the operation system and the multiple application programs according to an operation of a user. The user control interface device pertains to the user operation interface, and a user operates the personalized smart television management system through the user control interface device. When the personalized smart television management system provides the image to the display apparatus, the display apparatus displays a user interface. The user interface comprises a live broadcasting area, an application program area and a demand area. The live broadcasting area is disposed on a first block of a display area of the display apparatus. The application program area is disposed on a second block of the display area of the display apparatus. The demand area is disposed on a third block of the display area of the display apparatus. The demand area displays a notification video message of a specific application program of the application programs on a specific notification video message block. When the user points a virtual indicator toward the specific notification video message block of the demand area and performs a clicking operation through the user control interface device, the specific application program is enabled, and a specific notification video message in the specific notification video message block is broadcasted.

The present invention further provides a personalized smart television, which has an operation system and for providing an image to a display apparatus. The personalized smart television comprises a network access circuit, a storage circuit, a control circuit and a user control interface device. The network access circuit is used to be connected to Internet. The storage circuit is for storing the operation system and multiple application programs. The control circuit is coupled to the network access circuit and the storage circuit and for executing the operation system and the application programs according to an operation of a user. The user control interface device is for the user to operate the personalized smart television through the user control interface device. When the personalized smart television provides the image to the display apparatus, the display apparatus displays a user interface, wherein the user interface comprises a live broadcasting area, an application program area and a demand area. The live broadcasting area is disposed on a first block of a display area of the display apparatus. The application program area is disposed on a second block of the display area of the display apparatus. The demand area is disposed on a third block of the display area of the display apparatus. When the personalized smart television is connected to a specified server through the Internet, the demand area further comprises displaying a latest message video/audio notification block. When the user points a virtual indicator toward the latest message video/audio notification block of the demand area and performs a clicking operation through the user control interface device, a latest message video/audio corresponding to the latest message video/audio notification block is broadcasted.

In personalized smart television and the personalized smart television management system according to a preferred embodiment of the present invention, the personalized smart television management system is connected to a specified server, and the user can register an account through the personalized smart television management system. When the user uses a mobile device, the user can connect to the specified server through the account, and subscribe a specific video/audio. After the personalized smart television management system is powered on, the demand area displays a notification message of the specific video/audio on a second specific notification video message block. When the user points the virtual indicator toward the specific notification video message block of the demand area through the user control interface device, a preview playback of the specific notification video message in the specific notification video message block starts.

In personalized smart television and the personalized smart television management system according to a preferred embodiment of the present invention, the personalized smart television management system is connected to a specified server, and the user can register an account through the personalized smart television management system. When the personalized smart television management system is connected to the specified server through the account registered by the user, the demand area further comprises displaying an advertisement video/audio message notification block, wherein an advertisement video/audio in the advertisement video/audio message notification block is correspondingly displayed.

In personalized smart television and the personalized smart television management system according to a preferred embodiment of the present invention, the personalized smart television management system automatically connects to a specified server. When the personalized smart television management system is connected to the specified server through the Internet, the demand area comprises displaying a latest message video/audio notification block. When the user points the virtual indicator toward the specific notification video message block of the demand area and performs the clicking operation through the user control interface device, a latest message video/audio corresponding to the latest message video/audio notification block is broadcasted.

The present invention further provides a method for pushing information to a television device. The method comprises the steps of: providing a operation system to the television device for providing a image to a display device; starting the operation system; connecting to an Internet; entering a graphical user interface (GUI), wherein the graphical user interface comprises a live broadcasting area, an application program area and a demand area, wherein the live broadcasting area is disposed on a first block of a display area of the display apparatus, the application program area is disposed on a second block of the display area of the display apparatus, and the demand area is disposed on a third block of the display area of the display apparatus, wherein the demand area displays a notification video message of a specific application program of the application programs on a specific notification video message block, wherein when the user points a virtual indicator toward the specific notification video message block of the demand area and performs a clicking operation through the user control interface device, the specific application program is enabled, and a specific notification video message in the specific notification video message block is broadcasted.

The essence of the invention is to configure the live broadcasting area, the application program area and the demand area additionally in the graphical user interface of a smart TV or a smart video/audio provider. The video/audio broadcasted by the live broadcasting area is the video/audio directly broadcasted from the network or externally inputted. The application program area is the video/audio application program originally provided by the smart television or smart video/audio provider, or the application program installed by the user. The demand area is similar to the design of the dynamic wall. When the user moves the selection block to the live broadcasting area through the user control interface device, the user choose to place the frame, broadcasted by the live broadcasting area, to the full-screen state or zoom-out state by way of operating. When the user moves the selection block to the application program area through the user control interface device, the user can enable the selected application program by way of button clicking. When the user moves the selection block to the demand area through the user control interface device, the preview playback of the selected demand block starts. Also, the demand area is connected to the application program used by the user. So, after boot up, the user can receive the user's interested latest message pushed by the application program without missing any wonderful program.

Further scope of the applicability of the present invention will become apparent from the detailed description given hereinafter. However, it should be understood that the detailed description and specific examples, while indicating preferred embodiments of the present invention, are given by way of illustration only, since various changes and modifications within the spirit and scope of the present invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention.

FIG. 1A is a schematic view showing a conventional operation interface of a smart video television box with the Android operation system.

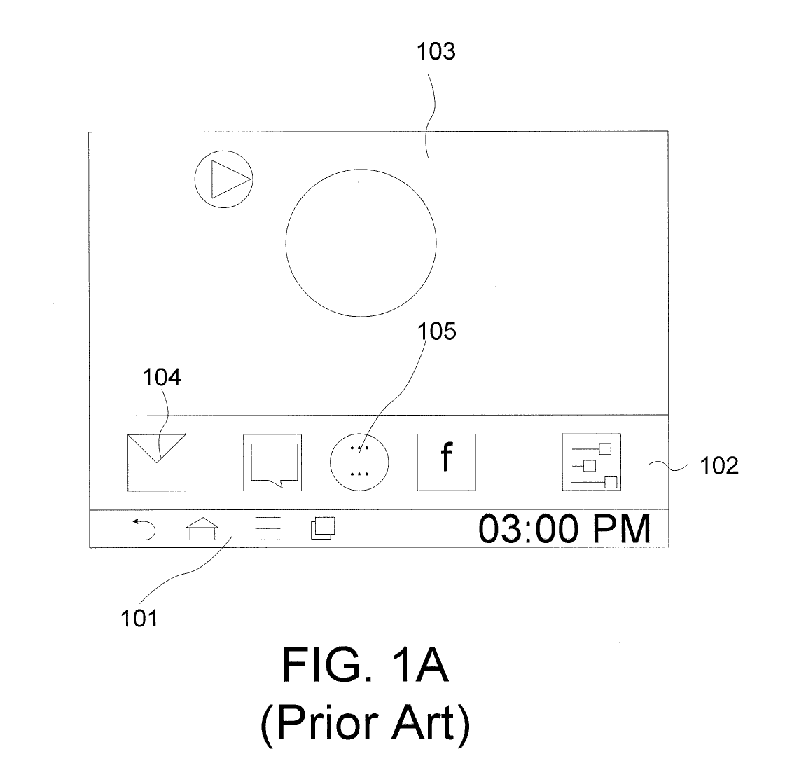

FIG. 1B is a schematic view showing a conventional operation interface of an APPLE TV television box.

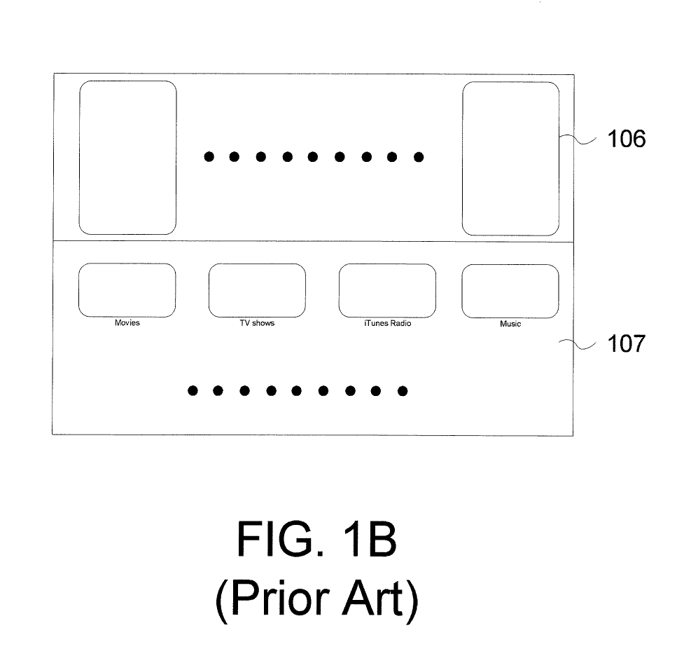

FIG. 2 is a schematic view showing a personalized smart television management system according to a preferred embodiment of the invention.

FIG. 3 is a schematic view showing a user operation interface of an operation system of the personalized smart television management system according to the preferred embodiment of the invention.

FIG. 4 is a schematic view showing a smart television according to a preferred embodiment of the invention.

FIG. 5 is a schematic view showing the user operation interface of the operation system of the smart television according to a preferred embodiment of the invention.

FIG. 6 is an architecture diagram showing a cloud management system of a personalized smart television management system according to an embodiment of the invention.

FIG. 7 is a flowchart showing a method for pushing information to television device according to an embodiment of the invention.

### DETAILED DESCRIPTION OF THE INVENTION

The present invention will be apparent from the following detailed description, which proceeds with reference to the accompanying drawings, wherein the same references relate to the same elements.

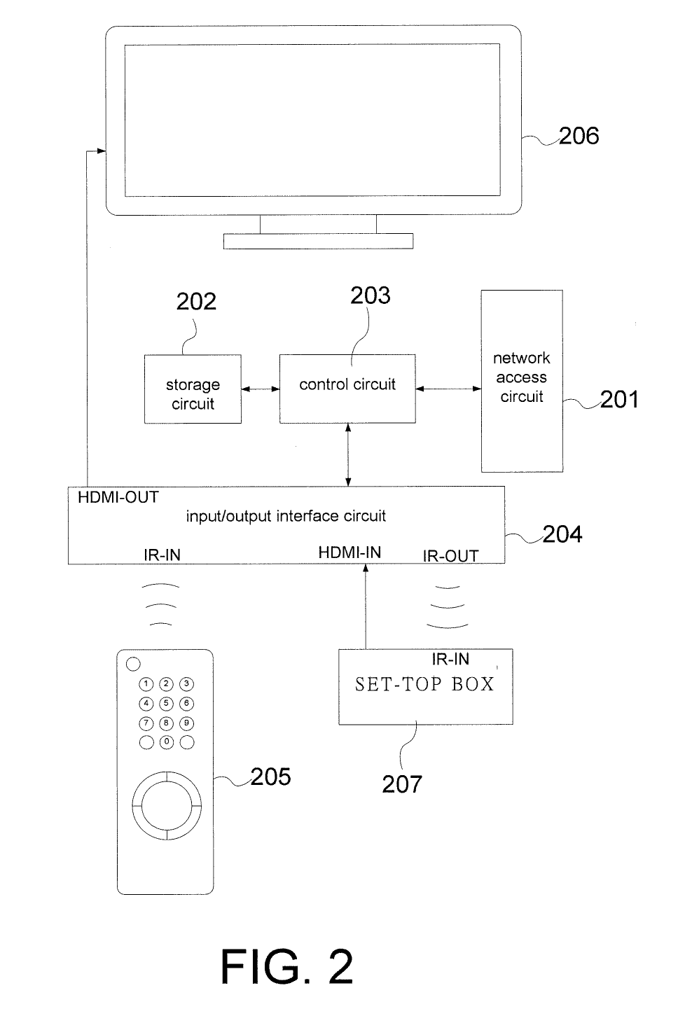

FIG. 2 is a schematic view showing a personalized smart television management system according to a preferred embodiment of the invention. Referring to FIG. 2, the personalized smart television management system may be a smart television box or a digital television set-top box with an operation system, and comprises a network access circuit 201, a storage circuit 202, a control circuit 203, and input/output interface circuit 204 and a remote control device 205. In order to make those skilled in the art understand the invention, a display apparatus (e.g., television) 206 is further depicted in the schematic view of the personalized smart television management system. The input/output interface circuit 204 has a high definition multimedia interface (HDMI) output interface HDMI-OUT. The personalized smart television management system is connected to the display apparatus 206 through the HDMI interface. In addition, the input/output interface circuit 204 further comprises an infrared input interface IR-IN, an infrared output interface IR-OUT, a HDMI input interface HDMI-IN, and the like. The infrared input interface is mainly used to receive an instruction outputted from the remote control device 205. The infrared output interface is for controlling an external television or a video converter, a set-top box 207 and the like. The video converter and the set-top box 207 may also input the video to the personalized smart television management system of this embodiment through the input/output interface circuit 204.

The network access circuit 201 is connected to Internet in a wired or wireless manner. The storage circuit 202 is for storing an operation system and multiple application programs. The control circuit 203 coupled to the network access circuit 201 and the storage circuit 202 is for operating the operation system and application programs according to an operation of a user. The remote control device 205 is a communicating bridge between the user and the personalized smart television management system of this embodiment. The user uses the remote control device 205 to operate the personalized smart television management system of this embodiment.

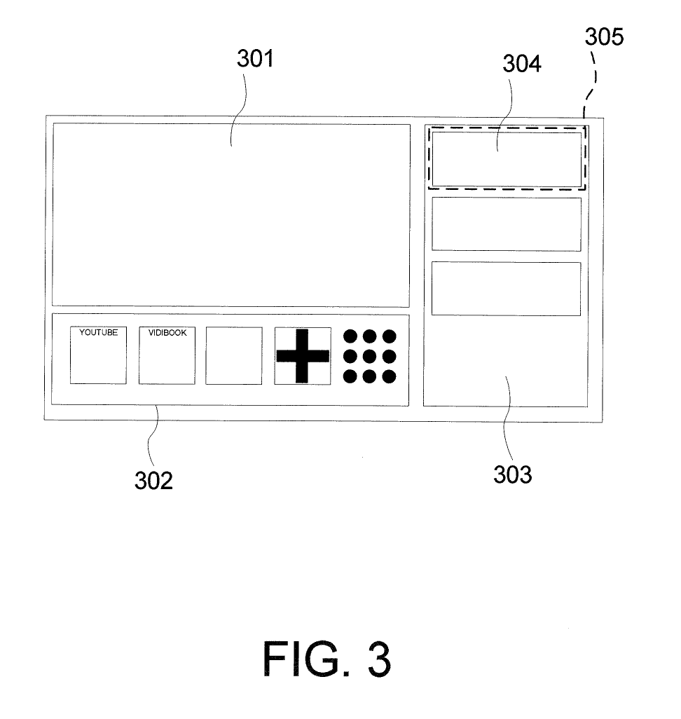

FIG. 3 is a schematic view showing a user operation interface of an operation system of the personalized smart television management system according to the preferred embodiment of the invention. Referring to FIG. 3, the user operation interface comprises a first block 301, a second block 302 and a third block 303. The first block 301 is a 16:9 rectangular area, and is mainly the live broadcasting area for broadcasting the video provided by an external video box, or the Internet live news video set by the user. The second block 302 is a longitudinal area for placement of multiple application program shortcuts and an application program drawer field. Generally speaking, the number of the application program shortcuts is restricted, and the user can put the application programs which are much more frequently used. If too many application program shortcuts are placed, the user cannot easily find the desired application program, so that the operation is not easy, and the memory is wasted.

The third block 303 is a rectangular block disposed on a right side of a frame and is a demand area. The configuration of the demand area is mainly for displaying the latest message pushed by the application program (i.e., the concept of the dynamic wall). The dynamic wall is to display the latest message on the area where the user can see, and continuously updates. The third block 303 of this embodiment comprises dynamic push-message fields for displaying pushed new messages in the dynamic wall, respectively.

Generally speaking, the user subscribes specific videos through some specific application programs. For example, the videos of some specific users placed on YOUTUBE can be subscribed as long as the account of YOUTUBE is logged in. Similarly, the series to be watched may also be set on China video platform PPSTREAM. In this embodiment, as long as the user's setting is completed, when a latest episode of the subscribed program is available and can be broadcasted on the video application program downloaded by the user, the update message of the episode number will be pushed to the dynamic push-message field 304 of the third block 303. In other words, the user can obtain that the new contents of the subscribed program are available after the personalized smart television management system is booted up directly from the dynamic wall (demand area 303). In addition, when the user moves a selection box 305 to the dynamic push-message field 304 of the pushed message through the remote control device 205, the user can start to enter the application program to play back the program by only clicking the button of the remote control device 205. In addition, in a preferred aspect of this embodiment, when the user moves the selection box 305 to the dynamic push-message field 304 of the pushed message through the remote control device 205, the dynamic push-message field 304 starts to preview and playback the program.

In another condition, the user can operate this personalized smart television management system to connect to a specified server, and register an account. Generally speaking, this specified server is managed by the manufacturer of this personalized smart television management system. In addition, the user can install the application program, provided by the personalized smart television management system, on his/her smart mobile device, such as a smart mobile phone or a tablet computer. When the user uses the mobile device to connect to the specified server through the registered account, the user can subscribe a specific video/audio through the application program. At this time, after the personalized smart television management system is powered on, the dynamic push-message field 304 of the demand area 303 displays the notification block of the subscribed specific video/audio, and the user can also playback the specific video/audio by directly clicking the button in a similar manner. Similarly, when the user points the selection box 305 toward the specific video/audio notification block of the demand area through the remote control device 205, the preview playback of the specific video/audio starts.

In addition, after the account is registered, the personalized smart television management system is connected to the specified server after being booted up, and collects the video, news and like clicked by the user with this account, so that the server can perform the statistical analysis according to the information clicked by the user with this account to analyze the user's interest. According to the above-mentioned statistical and analysis results, the specified server outputs a push advertisement message to the personalized smart television management system corresponding to this account. At this time, an advertisement video/audio message notification block is displayed in the demand area of the user's frame. When the user points the selection box 305 toward the advertisement video/audio message notification block of the demand area through the remote control device 205, a preview playback of the advertisement video/audio in the advertisement video/audio message notification block starts.

Furthermore, even if the user does not register an account, the personalized smart television management system may also automatically connect to the specified server. The specified server pushes the latest message toward the personalized smart television management system connected to Internet. At this time, a latest message notification block is displayed in the demand area 303 of the personalized smart television management system. The latest message may be the static or dynamic news, video, movie trailer or the like. When the latest message is the news and when the user points the selection box 305 toward the latest message video/audio notification block of the demand area 303 and clicks through the remote control device 205, the browser built in this personalized smart television management system opens the website address of this latest message and browses the news from Internet. If the latest message is the dynamic news, video or movie trailer and when the user points the selection box 305 toward the latest message video/audio notification block of the demand area 303 through the remote control device 205, a preview playback of a latest message video/audio in the latest message video/audio notification block starts. Also, the user can log into the specified server, or set the interested category or categories in the local settings. The interested category or categories are returned to the specified server, and the specified server transmits a corresponding latest message to the corresponding personalized smart television management system according to the interested category or categories set by each user.

The requirements of ordinary users on the television contents comprise live, demand and application contents. In this embodiment, the personalized smart television management system according to the preferred embodiment of the invention arranges the live, demand and application contents on the home page, and the contents are clearly determined according to the user's behavior. The source of the live content is selected by the user manually, and the user can select the external video or predetermined network live video. The application program can be installed by the user manually or by the television box in advance. The demand area in the right side field is implemented in the form of the dynamic wall. This is never present on the television, and will completely change the habit of the people in watching the television. For example, the news can be broadcasted on the left side, the dynamic wall continuously slides, and the user can select to broadcast the favorite film. Furthermore, the contents of the dynamic wall coming form the application program installed by the user may be, for example, the top or recommended application program, the YouTube channel subscribed by the user, the update of the film, the live video of the live application program, the update and latest message of the interested topic in the application program, and the like.

Compared with the conventional television box, the live requirements are not considered in almost all smart television boxes available in the markets. The embodiment of the invention provides an all new architecture (and management system) for the smart television box. In addition to the consideration of the live requirements, the contents of the application programs (Apps) are connected in series and presented onto the dynamic wall. In addition to giving more authorities back to the consumers, the users can see their interested contents, such as the live television, application program and demand dynamic contents as soon as the televisions of the users are powered on. Thus, the invention has the significant originality, subversive, and social progress.

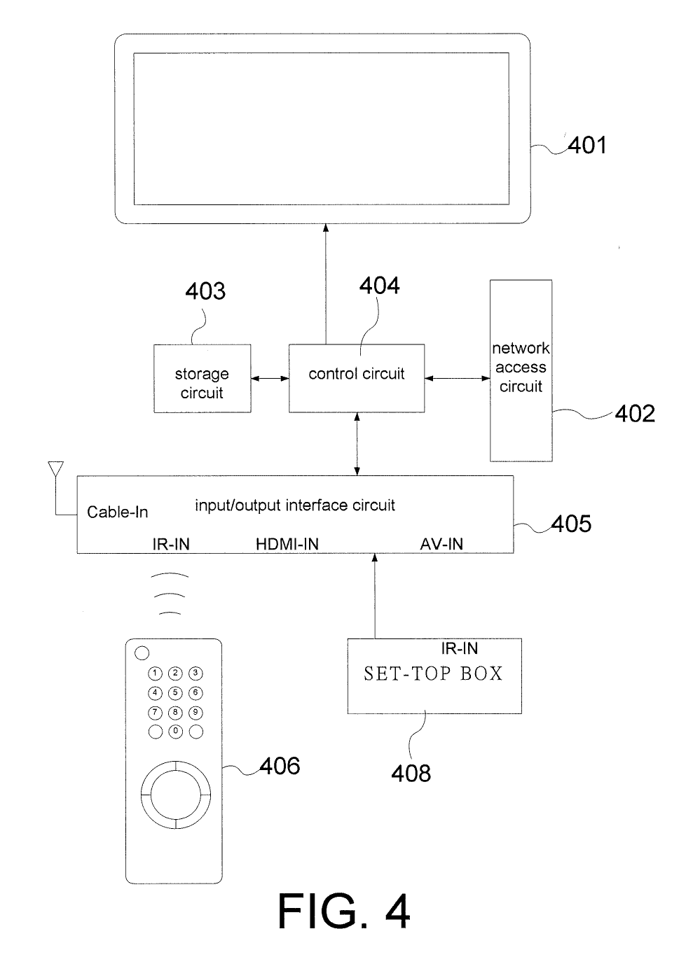

The above-mentioned embodiment relates to the externally connected television box. FIG. 4 is a schematic view showing a smart television according to a preferred embodiment of the invention. Referring to FIG. 4, the smart television comprises a display panel 401, a network access circuit 402, a storage circuit 403, a control circuit 404, an input interface circuit 405 and a remote control device 406. The input interface circuit 405 comprises an HDMI interface HDMI-IN, a composite video input interface AV-IN, an infrared input interface IR-IN, a wired/wireless television input interface Cable-In, and the like. The infrared input interface is mainly for receiving the instructions outputted from the remote control device 406.

The network access circuit 402 is connected to Internet in a wired or wireless manner. The storage circuit 403 is for storing an operation system and multiple application programs. The control circuit 404 coupled to the network access circuit 402 and the storage circuit 403 is for operating the operation system and the application programs according to an operation of the user. The remote control device 406 is a communicating bridge between the user and the smart television of this embodiment, and the user uses the remote control device 406 to operate the smart television of this embodiment.

Referring to FIGS. 2 and 4, there is only a little hardware difference between the smart television of FIG. 4 and the television box of FIG. 2. However, they have the same type of operation. So, the smart television of FIG. 4 and the television box of FIG. 2 pertain to the implemented aspects of the personalized smart television management system of the invention.

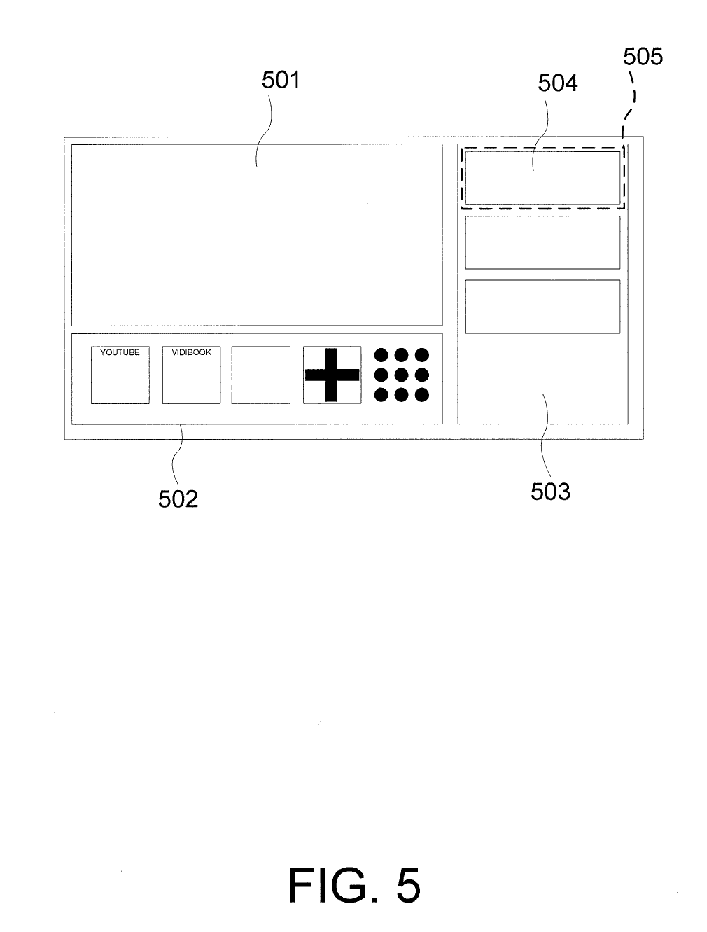

FIG. 5 is a schematic view showing the user operation interface of the operation system of the smart television according to a preferred embodiment of the invention. Referring to FIG. 5, the user operation interface comprises a first block 501, a second block 502 and a third block 503. The first block 501 is a 16:9 rectangular area, and is mainly a live broadcasting area for broadcasting the video provided by the external video box 408, the video inputted by the wired/wireless television input interface Cable-In, the video inputted by the composite video input interface AV-IN, or the Internet live news video set by the user. The second block 502 is a longitudinal area for placement of multiple application program shortcuts and an application program drawer field. Generally speaking, the number of the application program shortcuts is restricted, and the user can put the application programs which are much more frequently used. If too many application program shortcuts are placed, the user cannot easily find the desired application program, so that the operation is not easy, and the memory is wasted.

The third block 503 is a rectangular block disposed on a right side of a frame and is a demand area. The configuration of the demand area is mainly for displaying the latest message pushed by the application program. Generally speaking, the user subscribes specific videos through some specific application programs. For example, the videos of some specific users placed on YOUTUBE can be subscribed as long as the account of YOUTUBE is logged in. Similarly, the series to be watched may also be set on China video platform PPSTREAM. In this embodiment, as long as the user's setting is completed, when a latest episode of the subscribed program is available and can be broadcasted on the video application program downloaded by the user, the update message of the episode number will be pushed to a dynamic push-message field 504 of the third block 503. When the user moves a selection box 505 to the dynamic push-message field 504 of the pushed message, the preview playback of the program of the dynamic push-message field 504 starts. At this time, the user can start to enter the application program to play back the program by only clicking the button of the remote control device 406.

In another condition, the user can operate this smart television to connect to a specified server, and register an account. Generally speaking, this specified server is managed by the manufacturer of this personalized smart television. In addition, the user can install the application program, provided by the personalized smart television, on his/her smart mobile device, such as a smart mobile phone or a tablet computer. When the user uses the mobile device to connect to the specified server through the registered account, the user can subscribe a specific video/audio through the application program. At this time, after the smart television is powered on, the push message field 504 of the demand area 503 displays the notification block of the subscribed specific video/audio. Similarly, when the user points the selection box 505 toward the specific video/audio notification block of the demand area through the remote control device 406, a preview playback of the specific video/audio starts.

In addition, after the account is registered, the smart television is connected to the specified server after being booted up, and collects the video, news and like clicked by the user with this account, so that the server can perform the statistical analysis according to the information clicked by the user with this account to analyze the user's interest. Accordingly, the advertisement message is pushed to the demand area 503. At this time, the demand area of the user's frame displays an advertisement video/audio message notification block. When the user points the selection box 505 toward the advertisement video/audio message notification block of the demand area through the remote control device 406, a preview playback of the advertisement video/audio in the advertisement video/audio message notification block starts.

Furthermore, even if the user does not register an account, the smart television may also automatically connect to the specified server. The specified server pushes the latest message toward the smart television connected to Internet.

At this time, the demand area 503 of the smart television displays a latest message notification block. The latest message may be the static or dynamic news, video, movie trailer or the like. When the latest message is the news and when the user points the selection box 505 toward the latest message video/audio notification block of the demand area 503 and clicks through the remote control device 406, the browser built in this smart television opens the website address of this latest message and browses the news from Internet. If the latest message is the dynamic news, video or movie trailer and when the user points the selection box 505 toward the latest message video/audio notification block of the demand area 503 through the remote control device 406, a preview playback of a latest message video/audio in the latest message video/audio notification block starts. Also, the user can log into the specified server, or set the interested category or categories in the local settings. The interested category or categories is returned to the specified server, and the specified server transmits a corresponding latest message to the corresponding smart television according to the interested category or categories set by each user.

Although an infrared remote controller functions as the user control interface device to operate the personalized smart television management system according to the embodiment of the invention, those skilled in the art should know that under the condition that the personalized smart television management system has a universal serial bus (USB), a mouse, keyboard buttons or the like may also be adopted in the personalized smart television management system to function as the user control interface device to operate the personalized smart television management system according to the embodiment of the invention. Generally speaking, the mouse, keyboard and infrared remote controller pertain to the user control interface device, so the invention is not restricted thereto. In addition, the selection box 305 or 505 is described as an example of the embodiment. However, those skilled in the art should know that the cursor may also be adopted to operate the personalized smart television management system. The cursor and the selection box pertain to the virtual indicator, so the invention is not restricted thereto. In addition, although the mouse is the main device for controlling the cursor in the prior art, the invention does not intend to restrict the cursor as being controlled by the mouse. The invention may also adopt an infrared remote controller control cursor, and is thus not restricted thereto.

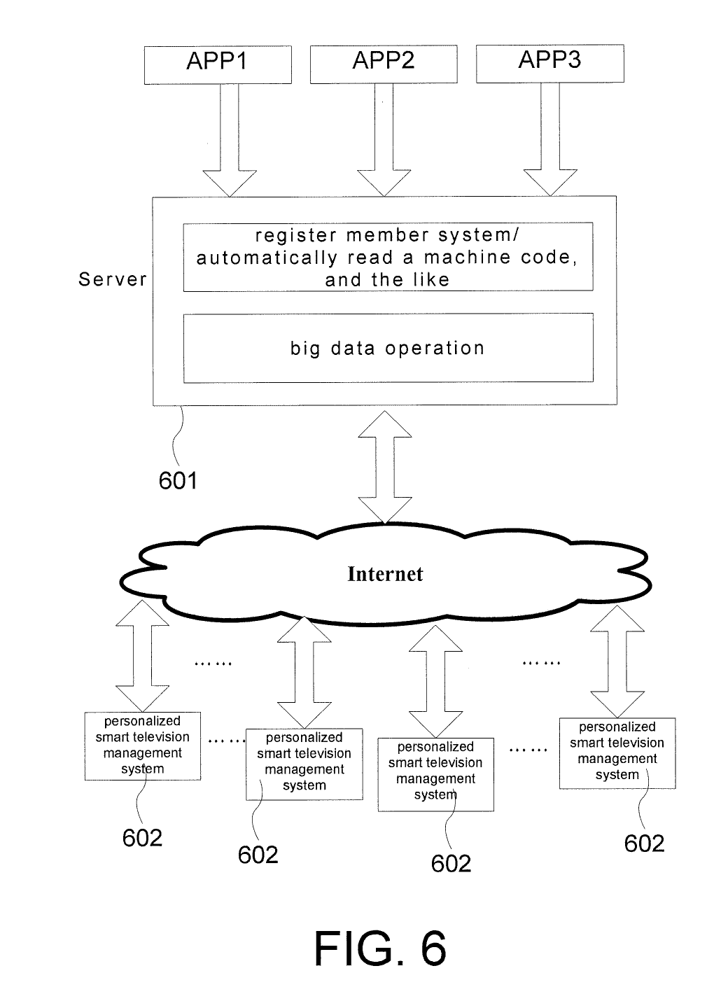

FIG. 6 is an architecture diagram showing a cloud management system of a personalized smart television management system according to an embodiment of the invention. Referring to FIG. 6, the cloud management system of the personalized smart television management system is provided by the manufacturer of the personalized smart television management system. The cloud management system comprises a server 601 and multiple personalized smart television management systems 602. The personalized smart television management systems 602 are connected to the server 601 when connecting to Internet. If one or multiple ones of the personalized smart television management systems 602 are logged into the server 601 with the accounts and passwords, the server 601 manages the information of the personalized smart television management systems logged into the server 601, such as the broadcasted network videos, the watched news or the like, and performs the statistical results to combine they into a big database. Thus, the server 601 pushes the user's interested latest message to the corresponding personalized smart television management system according to the watched information of this account. Of course, the message, such as the latest message of the application program chosen by the provider, still can be pushed to the device, which does not log into the server by the account and password.

In the above-mentioned embodiments, in addition to the registration using the user's account and password, each personalized smart television management system 602 has a unique machine code, such as the media access control address, in a general sense. The provider's server can judge the connected device according to the machine code, and determine the information, such as the network video played by the user, the watched news or the like, and perform the statistics to combine the statistical results into a database. Similarly, the server 601 can push the user's interested latest message to the corresponding personalized smart television management system according to the watched information of this account.

Similarly, because the television device logs into the specified server, the specified server collects the video, audio, news and/or the like clicked by the user to judge the user's interest. Accordingly, an advertisement message may be automatically pushed to the demand area. The user can point the virtual indicator toward the advertisement video/audio message notification block of the demand area by way of operating, and a preview playback of an advertisement video/audio in the advertisement video/audio message notification block starts. The user may also open the news, advertisement, subscribed video, preferred latest message or the like on the dynamic wall by way of clicking.

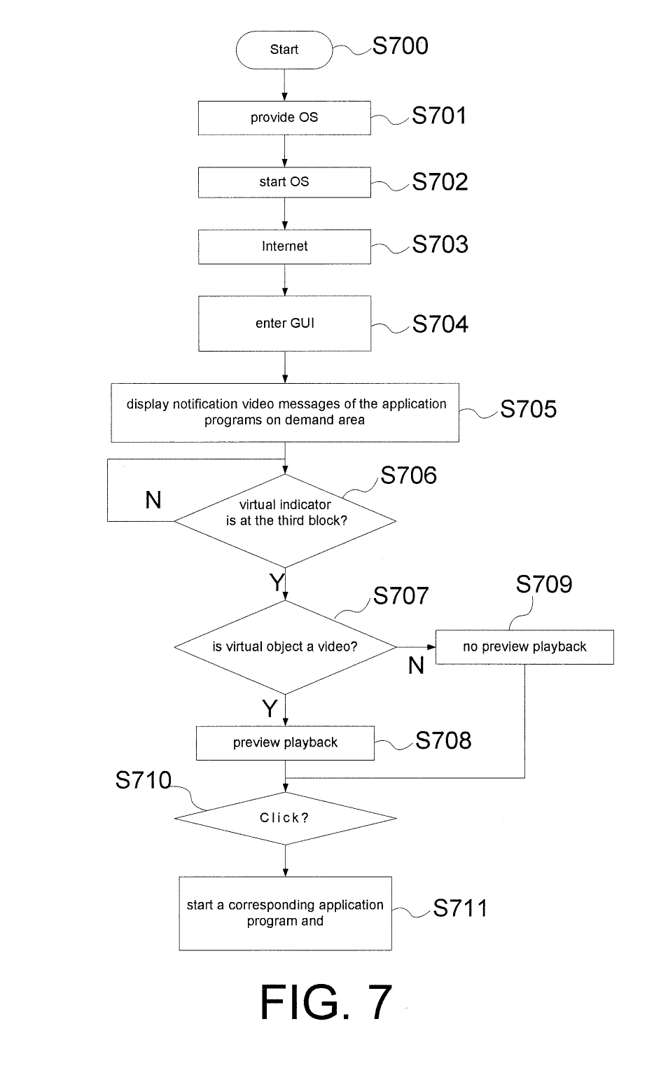

According to the abovementioned two embodiments, a method for pushing information to television device can be summarized. FIG. 7 is a flowchart showing a method for pushing information to television device according to an embodiment of the invention. Referring to FIG. 7, the method includes the steps as follows.

In step S700, the method starts.

In step S701, an operation system is provided to a television device for providing an image to a display device. The abovementioned television device may be a personalized smart television management system, a set-top box, a TV box or the smart TV in the embodiment of the present invention.

In step S702, the operation system starts.

In step S703, the Internet is connected.

In step S704, a graphical user interface (GUI) is entered. The graphical user interface includes a live broadcasting area, an application program area and a demand area. The live broadcasting area is disposed on a first block of a display area of the display apparatus, the application program area is disposed on a second block of the display area of the display apparatus, and the demand area is disposed on a third block of the display area of the display apparatus.

In step S705, the demand area displays notification video messages of the application programs.

In step S706, it is determined whether a virtual indicator is at the third block.

In step S707, it is determined whether a virtual object indicated by the virtual indicator is a video object. When the determination is positive, the step S708 is performed. When the determination is negative, the step S709 is performed.

In step S708, a preview playback is performed. When the user points the virtual indicator toward the specific notification video message block of the demand area through an operation, such as a mouse operation, a keyboard operation, IR remote control operation, the specific notification video message in the specific notification video message block starts to playback in preview playback mode.

In step S709, a preview playback is not performed.

In step S710, it is determined whether a clicking operation is performed or not. When the determination is positive, the step S711 is performed.

In step S711, a corresponding application program is started up according to the content of the specific notification video message block of the demand area, and the content of the specific notification video message block of the demand area is opened.

Similarly, it is assumed that the television device is automatically connected to the specified server through the Internet, user can register an account through the personalized smart television management system. The user may use its mobile device to download a application program corresponding to the specified server, and log in the specified server through its mobile device by the registered account. When the user connects to the specified server through the account by the mobile device, the user can subscribes a specific video/audio. After the television device is powered on and logged into the specified server, the demand area displays the specific video/audio on the specific notification video message block which subscribed by user. At this time, through the steps S706, S707 and S708, the user can perform a preview playback to the specific video/audio on the specific notification video message block.

Analogously, because the television device would log into the specified server, and the specified server would collect video, audio, news, which user clicks, to determine users' interests. Thus, the demand area can be automatically pushed an advertisement message. When the user points the virtual indicator toward the advertisement notification video message block of the demand area through an operation, the preview playback of the advertisement video/audio in the advertisement notification video message block starts. The user also can open advertisement, subscribed video or latest preferred news on the live feed (the demand area) by click.

In summary, the essence of the invention is to configure the live broadcasting area, the application program area and the demand area additionally in the graphical user interface of a smart TV or a smart video/audio provider. The video/audio broadcasted by the live broadcasting area is the video/audio directly broadcasted from the network or externally inputted. The application program area is the video/audio application program originally provided by the smart television or smart video/audio provider, or the application program installed by the user. The demand area is similar to the design of the dynamic wall. When the user moves the selection block to the live broadcasting area through the user control interface device, the user choose to place the frame, broadcasted by the live broadcasting area, to the full-screen state or zoom-out state by way of operating. When the user moves the selection block to the application program area through the user control interface device, the user can enable the selected application program by way of button clicking. When the user moves the selection block to the demand area through the user control interface device, the preview playback of the selected demand block starts. Also, the demand area is connected to the application program used by the user. So, after boot up, the user can receive the user's interested latest message pushed by the application program without missing any wonderful program.

The invention breaks through the existing category and provides the first television system with the fully new pattern, in which the consumer can dominate the contents. With the fully new concept and technology, the user obtains the unprecedented dominating right, and only the essential authority of the system administrator is reserved. The invention is based on the market requirements to redefine the home entertainment, to fully enhance the consumer satisfaction, and to make various content providers and system service providers precisely dominate the market requirements to provide the better service and contents. The contents, such as live sources, application programs and demand contents, that are to be watched by the consumers on the television, are determined according to the consumer's interest. The system administrator only has the suggesting or recommending rights without the completely dominating right of the conventional television. This is the real progress of the technological civilization, and is also the essence possessed by the new television product most suitable for the Internet era.

While the present invention has been described by way of examples and in terms of preferred embodiments, it is to be understood that the present invention is not limited thereto. To the contrary, it is intended to cover various modifications. Therefore, the scope of the appended claims should be accorded the broadest interpretation so as to encompass all such modifications.

What is claimed is:

1. A personalized smart television management system having an operation system for providing an image to a display apparatus, the personalized smart television management system comprising:
a network access circuit to be connected to Internet;
a storage circuit for storing the operation system and multiple application programs;
a control circuit, which is coupled to the network access circuit and the storage circuit and executes the operation system and the application programs according to an operation of a user;
a user control interface device, through which the user operates the personalized smart television management system,
wherein when the personalized smart television management system provides the image to the display apparatus, the display apparatus displays a user interface, wherein the user interface comprises:
a live broadcasting area disposed on a first block of a display area of the display apparatus;
an application program area disposed on a second block of the display area of the display apparatus; and
a demand area disposed on a third block of the display area of the display apparatus;
wherein the demand area displays a notification video message of a specific application program of the application programs on a specific notification video message block,
wherein when the user points a virtual indicator toward the specific notification video message block of the demand area and performs a clicking operation through the user control interface device, the specific application program is enabled, and a specific notification video message in the specific notification video message block is broadcasted.

2. The personalized smart television management system according to claim 1, wherein when the user points the virtual indicator toward the specific notification video message block of the demand area through the user control interface device, a preview playback of the specific notification video message in the specific notification video message block starts.

3. The personalized smart television management system according to claim 1, wherein the personalized smart television management system is connected to a specified server, and the user can register an account through the personalized smart television management system, wherein
when the user uses a mobile device, the user can connect to the specified server through the account, and subscribe a specific video/audio; and
after the personalized smart television management system is powered on, the demand area displays a notification message of the specific video/audio on a second specific notification video message block.

4. The personalized smart television management system according to claim 3, wherein when the user points the virtual indicator toward the second specific notification video message block of the demand area and performs the clicking operation through the user control interface device, the specific video/audio is broadcasted.

5. The personalized smart television management system according to claim 3, wherein the user points the virtual indicator toward the second specific notification video message block of the demand area through the user control interface device, a preview playback of the specific video/audio in the second specific notification video message block starts.

6. The personalized smart television management system according to claim 1, wherein the personalized smart television management system is connected to a specified server, and the user can register an account through the personalized smart television management system, wherein
when the personalized smart television management system is connected to the specified server through the account registered by the user, the demand area further comprises displaying an advertisement video/audio message notification block, wherein an advertisement video/audio in the advertisement video/audio message notification block is correspondingly displayed.

7. The personalized smart television management system according to claim 6, wherein the user points the virtual indicator toward the advertisement video/audio message notification block of the demand area through the user control interface device and performs the clicking operation, the advertisement video/audio in the advertisement video/audio message notification block is correspondingly broadcasted.

8. The personalized smart television management system according to claim 6, wherein the user points the virtual indicator toward the advertisement video/audio message notification block of the demand area through the user control interface device, and a preview playback of the advertisement video/audio in the advertisement video/audio message notification block starts.

9. The personalized smart television management system according to claim 6, wherein the advertisement video/audio is a video/audio clicked by the user logging into the account, and the specified server automatically provides contents of the advertisement video/audio message notification block to the personalized smart television management system according to a statistical result after statistics is performed.

10. The personalized smart television management system according to claim 6, wherein the user sets an interested category in the specified server through the registered account, and the specified server automatically provides contents of the advertisement video/audio message notification block to the personalized smart television management system according to the interested category.

11. The personalized smart television management system according to claim 1, wherein the personalized smart television management system automatically connects to a specified server, wherein:
when the personalized smart television management system is connected to the specified server through the Internet, the demand area comprises displaying a latest message video/audio notification block; and
when the user points the virtual indicator toward the specific notification video message block of the demand area and performs the clicking operation through the user control interface device, a latest message video/audio corresponding to the latest message video/audio notification block is broadcasted.

12. The personalized smart television management system according to claim 11, wherein the user points the virtual indicator toward the latest message video/audio notification block of the demand area through the user control interface device, and a preview playback of the latest message video/audio corresponding to the latest message video/audio notification block starts.

13. The personalized smart television management system according to claim 11, wherein the user sets an interested category in the specified server through the specified server, and the specified server automatically provides the latest message video/audio to the personalized smart television management system according to the interested category.

14. A personalized smart television, which has an operation system and for providing an image to a display apparatus, the personalized smart television comprising:
a network access circuit to be connected to Internet;
a storage circuit for storing the operation system and multiple application programs;
a control circuit, which is coupled to the network access circuit and the storage circuit and for executing the operation system and the application programs according to an operation of a user;
a user control interface device, wherein the user operates the personalized smart television through the user control interface device;
wherein when the personalized smart television provides the image to the display apparatus, the display apparatus displays a user interface, wherein the user interface comprises:
a live broadcasting area disposed on a first block of a display area of the display apparatus;
an application program area disposed on a second block of the display area of the display apparatus; and
a demand area disposed on a third block of the display area of the display apparatus, wherein
when the personalized smart television is connected to a specified server through the Internet, the demand area further comprises displaying a latest message video/audio notification block,
wherein when the user points a virtual indicator toward the latest message video/audio notification block of the demand area and performs a clicking operation through the user control interface device, a latest message video/audio corresponding to the latest message video/audio notification block is broadcasted.

15. The personalized smart television according to claim 14, wherein the user points the virtual indicator toward the latest message video/audio notification block of the demand area through the user control interface device, and a preview playback of the latest message video/audio corresponding to the latest message video/audio notification block starts.

16. The personalized smart television according to claim 14, wherein the user sets an interested category in the specified server through the specified server, and the specified server automatically provides the latest message video/audio to the personalized smart television according to the interested category.

17. A method for pushing information to a television device, comprising:
providing a operation system to the television device for providing a image to a display device;
starting the operation system;
connecting to an Internet; and
entering a graphical user interface,
wherein the graphical user interface comprises a live broadcasting area, an application program area and a demand area,
wherein the live broadcasting area is disposed on a first block of a display area of the display apparatus, the application program area is disposed on a second block of the display area of the display apparatus, and the demand area is disposed on a third block of the display area of the display apparatus,
wherein the demand area displays a notification video message of a specific application program of the application programs on a specific notification video message block,
wherein when the user points a virtual indicator toward the specific notification video message block of the demand area and performs a clicking operation through the user control interface device, the specific application program is enabled, and a specific notification video message in the specific notification video message block is broadcasted.

18. The method according to claim 17, wherein when the user points the virtual indicator toward the specific notification video message block of the demand area through the user control interface device, a preview playback of the specific notification video message in the specific notification video message block starts.

19. The method according to claim 17, wherein the television device is connected to a specified server, and the user can register an account through the television device, wherein
when the user uses a mobile device, the user can connect to the specified server through the account, and subscribe a specific video/audio; and
after the television device is powered on, the demand area displays a notification message of the specific video/audio on a second specific notification video message block.

20. The method according to claim 19, wherein when the user points the virtual indicator toward the second specific notification video message block of the demand area and performs the clicking operation through the user control interface device, the specific video/audio is broadcasted.
